(19) United States
(12) Patent Application Publication
(10) Pub. No.: US 2007/0068576 A1
(43) Pub. Date: Mar. 29, 2007

(54) METHODS AND SYSTEMS FOR FILLING A VESSEL WITH A COMPRESSED GAS

(76) Inventors: Steven A. Fisher, Brookfield, IL (US); Edward F. Steiner, Downers Grove, IL (US)

Correspondence Address: Ms. Linda K. Russell;Air Liquide Intellectual Property Dept., Suite 1800, 2700 Post Oak Blvd., Houston, TX, 77056, US

(21) Appl. No.: 11/460,313

(22) Filed: Jul. 27, 2006

Related U.S. Application Data
(60) Provisional application No. 60/720,959, filed on Sep. 27, 2005.

(51) Int. Cl. F16K 15/00

(52) U.S. Cl. 137/455

(57) ABSTRACT

Systems and methods for filling a vessel with a compressed process gas. In a particular embodiment the process gas is a dry gas, such as ozone and a dry pressurizing gas, such as carbon dioxide, is used to drive the process gas through an intermediate gas piston unit and then into a process vessel. The pressurizing gas may be selected to be nonreactive with the process gas.

### CROSS-REFERENCE TO RELATED APPLICATIONS

This application claims the benefit under 35 U.S.C. § 119(e) to provisional application No. 60/720,959, filed Sep. 27, 2005, the entire contents of which are incorporated herein by reference.

### BACKGROUND

1. Field of the Invention

The present invention is generally directed to a method and system for compressing a fluid.

2. Description of the Related Art

Industrial applications often call for pressurized sources of fluids. For example, some industrial applications require pressurized ozone. Known apparatus for pressurizing ozone include water ring compressors, solid pistons, water pistons and diaphragm pumps.

While these techniques work adequately for industrial ozone generators operating at relatively low pressures (for ozone applications occurring at essentially atmospheric pressure), challenges arise for ozone applications requiring greater pressures (e.g., greater than about 20 psig). Ozone is a highly reactive oxidant, making it difficult to pressurize. Pressurization is further complicated by the need to avoid moisture contamination in the ozone stream, which may be necessary for certain applications requiring anhydrous pressurized ozone.

Accordingly, there is a need for method and system for compressing a fluid, such as ozone. Preferably, the method and system provide for dry compression of the fluid.

### SUMMARY

The present invention generally provides for systems and methods for filling a vessel with a compressed process gas. In a particular embodiment the process gas is a dry gas, such as ozone and a dry pressurizing gas, such as carbon dioxide, is used to drive the process gas through an intermediate gas piston unit and then into a process vessel. The pressurizing gas may be selected to be nonreactive with the process gas.

One embodiment provides a method for pressurizing a process vessel with a gas. The method includes providing a first gas source containing a process gas having a first density; providing a second gas source containing a pressurizing gas having a second density, wherein the pressurizing gas is selected to be nonreactive with the process gas; and providing a gas piston unit comprising a plurality of pressurizing vessels connected in a series so that an outlet of each pressurizing vessel is connected to an inlet of a next pressurizing vessel in the series, except that an outlet of a last pressurizing vessel in the series is connected to an inlet of the process vessel; wherein an inlet of the first pressurizing vessel is selectively fluidly coupled to the first and second gas sources. The method further includes flowing the process gas from the first gas source to the gas piston unit, whereby the process gas enters the inlet of the first pressurizing vessel to fill the first pressurizing vessel and then flows successively to each of the other pressurizing vessel in the series and flows into the process vessel from the last pressurizing vessel; terminating the flow of process gas upon reaching a first desired pressure in the process vessel; and flowing the pressurizing gas from the second gas source to the gas piston unit, whereby the pressurizing gas enters the inlet of the first pressurizing vessel and forms a gas piston; wherein the gas piston, with continued flow of the pressurizing gas, volumetrically expands from the first pressurizing vessel and successively into each of the other pressurizing vessels and then into the process vessel, thereby driving the process gas successively through the series of pressurizing vessels and into the process vessel.

Another method provides for filling a vessel with a fluid. The method includes fluidly coupling a pressurizing vessel to a first fluid source, containing a first fluid having a first density, in order to at least partially fill the pressurizing vessel with the first fluid; wherein the pressurizing vessel is fluidly coupled to a first vessel of a plurality of vessels, N, connected to each other in series with fluid connections, and wherein a filling vessel is fluidly coupled to a last vessel of the plurality of vessels and is to be filled with the first fluid; isolating the pressurizing vessel from the first fluid source after at least partially filling the pressurizing vessel to a desired point; and fluidly coupling the at least partially filled pressurizing vessel to a second fluid source containing a second fluid having a second density and selected to be non-reactive with respect to the first fluid, whereby the first and second fluids remain substantially separate from each other in the pressurizing vessel and the second fluid forms a fluid piston in the pressurizing vessel driving the first fluid from the pressurizing vessel into the first vessel of the plurality of vessels, the first fluid then being caused to flow successively through the plurality of vessels and then from the last vessel into the filling vessel during continued input of the second fluid to the pressurizing vessel.

Yet another embodiment provides for an apparatus including a first gas source for providing a process gas having a first density; a second gas source for providing a pressurizing gas having a second density, wherein the pressurizing gas is selected to be nonreactive with the process gas; a gas piston unit comprising a plurality of pressurizing vessels connected in a series so that an outlet of each pressurizing vessel is connected to an inlet of a next pressurizing vessel in the series, except that an outlet of a last pressurizing vessel in the series is connected to the inlet of a process vessel to be pressurized with the process gas; wherein an inlet of the first pressurizing vessel is selectively fluidly coupled to the first and second gas sources; and a controller configured to perform a pressurizing operation for pressurizing the process vessel with compressed process gas. In one embodiment, the operation comprises flowing the process gas from the first gas source to the gas piston unit, whereby the process gas enters the inlet of the first pressurizing vessel to fill the first pressurizing vessel and then flows successively to each of the other pressurizing vessel in the series and flows into the process vessel from the last pressurizing vessel; terminating the flow of process gas upon reaching a first desired pressure in the process vessel; and flowing the pressurizing gas from the second gas source to the gas piston unit, whereby the pressurizing gas enters the inlet of the first pressurizing vessel and forms a gas piston; wherein the gas piston, with continued flow of the pressurizing gas, volumetrically expands from the first pressurizing vessel and successively into each of the other pressurizing vessels and then into the process vessel, thereby driving the process gas successively through the series of pressurizing vessels and into the process vessel.

Still another embodiment provides for an apparatus including a first gas source for providing ozone; a second gas source for providing a pressurizing gas having a second density, wherein the pressurizing gas is selected to be nonreactive with the process gas; and a gas piston unit. The gas piston unit includes a plurality of pressurizing vessels connected in a series so that an outlet of each pressurizing vessel is connected to an inlet of a next pressurizing vessel in the series, except that an outlet of a last pressurizing vessel in the series is connected to an inlet of a process vessel to be pressurized with the process gas. The respective terminal ends of the respective inlets of the pressurizing vessels and the process vessel are disposed at a first end of the respective vessel and the respective outlets of the pressurizing vessels are disposed at a second end of the respective pressurizing vessel, the first end being opposite from the second end. The inlet of the first pressurizing vessel is selectively fluidly coupled to the first and second gas sources; the pressurizing vessels each have a first volume and the process vessel has a second volume, greater than the first volume; and wherein the first volume and the number of pressurizing vessels are selected on the basis of the second volume to be filled with the process gas.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a pressuring system for filling a process vessel with a compressed process gas, according to one embodiment.

FIG. 2 is a flow diagram illustrating the operation of the system of FIG. 1, according to one embodiment.

FIG. 3 is a pressuring system for filling a process vessel with a compressed process gas, according to another embodiment.

FIG. 4 is an embodiment of a pressurizing vessel.

FIG. 5 is another embodiment of a pressurizing vessel.

### DESCRIPTION OF PREFERRED EMBODIMENTS

The present invention is generally directed to a system and method for compressing a fluid, such as ozone. Although specific embodiments are described with respect to ozone the invention is not so limited, and persons skilled in the art will recognize embodiments for other fluids, all within the scope of the present invention.

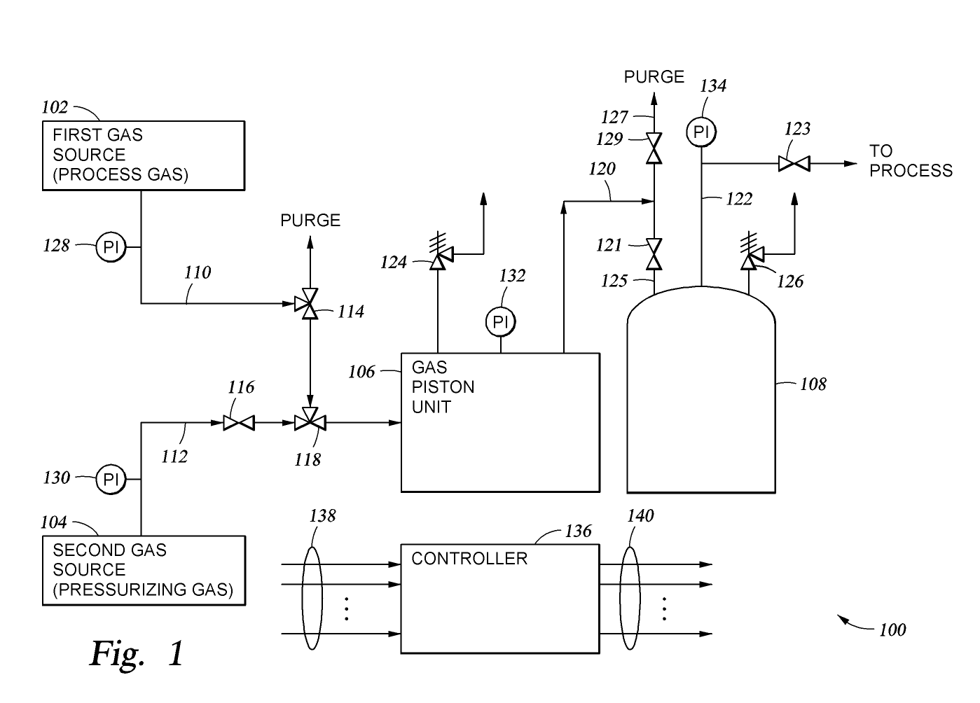

Referring now to FIG. 1, a pressurizing system 100 is shown, according to one embodiment of the present invention. The pressurizing system generally includes a first gas source 102 and a second gas source 104 in selective fluid communication with a gas piston unit 106. According to one embodiment, the first gas source 102 contains a process gas to be delivered to a process tank 108, while the second gas source 102 contains a pressurizing gas. As used herein “process tank 108” refers to a destination tank to which a process gas (e.g., ozone) is to be delivered via the pressurization mechanisms disclosed herein. In one embodiment, the densities of the process gas and the pressurizing gas are different and the gases are non-reactive with respect to each other.

The first gas source 102 is fluidly coupled to the gas piston unit 106 with a first supply line 110. The second gas source 104 is fluidly coupled to the gas piston unit 106 with a second supply line 112. Fluid communication between the gas sources and the gas piston unit is controlled with one or more valves. Illustratively, each of the supply lines 110, 112 include an in-line valve 114, 116, respectively. The first and second supply lines 110, 112 terminate at a third valve 118 that selectively couples one of the first gas source 102 and the second gas source 104 to the gas piston unit 106.

The gas piston unit 106 is fluidly coupled the process tank 108 via a third supply line 120. A fourth valve 121 is disposed in the third supply line 120 and operable to selectively isolate the gas piston unit 106 from the process tank 108. In one embodiment, the supply line 120 is coupled to an inlet 125 that terminates within the process tank 108 in a manner that at least mitigates the mixing of the process gas and the pressurizing within the process tank 108. Illustrative embodiments will be described below. As shown in FIG. 1, the supply line is also coupled to a purge line 127 having a valve 129. In one embodiment, the process tank 108 is filled with the process gas and then decoupled from the third supply line 120. The process tank 108 may then be transported to a desired location for use as a process gas source in a particular application. Optionally, the process tank 108 may remain coupled to the gas piston unit 106 via the third supply line 120 while simultaneously providing process gas to a process via a fourth supply line 122. A fifth valve 123 is disposed in the fourth supply line 122 and operable to selectively control the flow of gas through the fourth supply line 122.

In one embodiment, the pressurization system 100 may include one or more relief valves. Illustratively, a first relief valve 124 is shown disposed on the gas piston unit 106 and a second relief valve 126 is shown disposed on the process tank 108. The relief valves 124, 126 may each be configured to vent the pressurized contents of the gas piston unit 106 and the process tank 108, respectively, to atmosphere at respective predetermined internal pressures.

Further, the system 100 may be configured with one or more pressure gauges, flow meters or other devices for measuring, monitoring or controlling flow rates, pressures, temperatures, etc. For example, the illustrative system 100 shown in FIG. 1 includes a plurality of pressure gauges. A first pressure gauge 128 and a second pressure gauge 130 are shown disposed on the first supply line 110 and the second supply line 112, respectively. A third pressure gauge 132 is shown disposed on the gas piston unit 106. A fourth pressure gauge 134 is shown disposed in the third supply line 122.

It is contemplated that each of the pressure gauges 128-134 (and other devices included with the system 100) may be monitored by a controller 136. The comptroller 136 may be configured to maintain desired pressures within each of the respective system components. The controller 136 may also be configured to control the respective valves of the system 100. Accordingly, FIG. 1 shows the controller 136 receiving a plurality of input signals (e.g., representative of respective pressure readings provided by the pressure gauges) and issuing a plurality of command signals 140 (e.g., to control the respective positions of the valves).

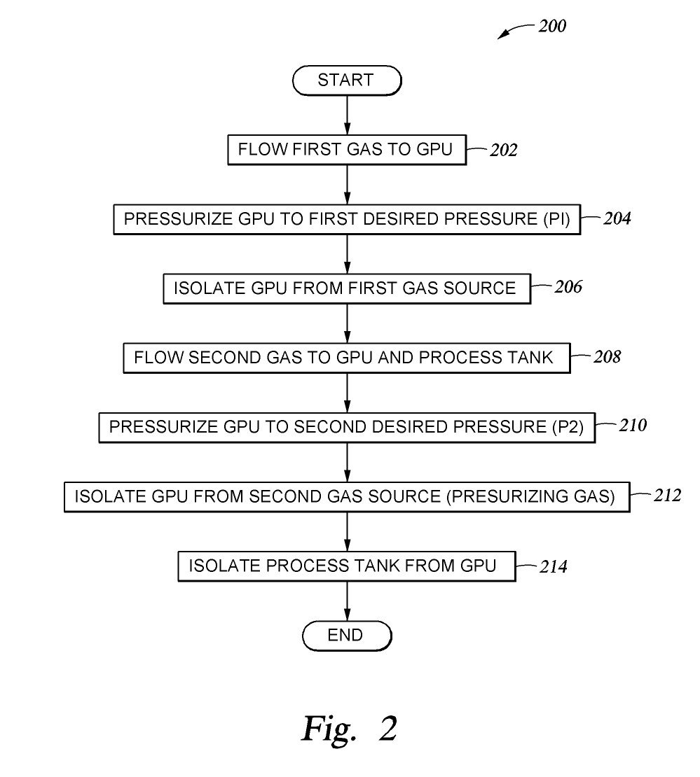

The operation of the system 100, according to one embodiment, will now be described with simultaneous reference to FIG. 1 and FIG. 2. FIG. 2 shows a method 200 which may be implemented by the controller 136. At step 202, the flow of a first gas (from one of the first gas source 102 or the second gas source 104) to the gas piston unit 106 is initiated. For purposes of illustration it will be assumed that at step 202 the first gas source, containing a process gas, it is fluidly coupled to the gas piston unit 106. Accordingly, the first valve 114 is opened (while the second valve 116 is closed) and the third valve 118 is set to a position allowing fluid communication between the first gas source 102 and the gas piston unit 106. In a particular embodiment, the process gas is ozone. At step 204 the gas piston unit 106 is pressurized to a desired first pressure with the ozone, as may be determined by the third pressure gauge 132. During step 204, the sixth valve 129 may be open while the fifth valve 121 is closed, thereby allowing the volume of the gas piston unit 106 to be purged by the incoming ozone.

Having established the first desired pressure, the gas piston unit 106 is isolated from the first gas source, at step 206, by closing the first and third valves 114, 118. The gas piston unit 206 now contains a volume of ozone. At step 208, the pressurizing gas is flowed from the second gas source 104 to the gas piston unit 106 by opening the second valve 116 and setting the third valve 118 to allow fluid communication from the supply line 112 into the gas piston unit 106. As noted above, in one embodiment, the densities of the process gas and the pressurizing gas are different and the gases are non-reactive with respect to each other. For example, in one embodiment the pressurizing gas may be carbon dioxide. Carbon dioxide may be advantageously used as it is anhydrous and denser than ozone. Accordingly, by controlling the introduction of carbon dioxide into the gas piston unit 106 the carbon dioxide forms a gaseous piston within the gas piston unit 106 that acts to drive the ozone from the gas piston unit 106 into the process tank 108 via the supply line 120 (during which time the fourth valve 121 is open and the sixth valve 129 is closed). In various embodiments, controlling the introduction of the carbon dioxide into the gas piston unit 106 includes controlling the flow rate of the carbon dioxide and the outlet of the carbon dioxide into the gas piston unit 106, as will be described in more detail below.

Flowing the pressurizing gas is continued until reaching a second desired pressure within the gas piston unit 106, at step 210. The gas piston unit 106 is then isolated from the second gas source 104 at step 212. The process tank 108 is then isolated from the gas piston unit 106 at step 214. In this manner, the process tank 108 has been now been pressurized with a process gas (ozone in this example) and may be used as a source of process gas for a particular application.

It should be noted that both batch and continuous modes of operation are contemplated. In other words, in a batch operation the process tank 108 is periodically depleted of process gas and then refilled with process gas via the gas piston unit 106, wherein the refilling requires that the tank 108 be unavailable as a source of process gas for a particular application. In contrast, a continuous mode of operation allows the process tank 108 to be refilled with process gas while simultaneously providing process gas for a particular application.

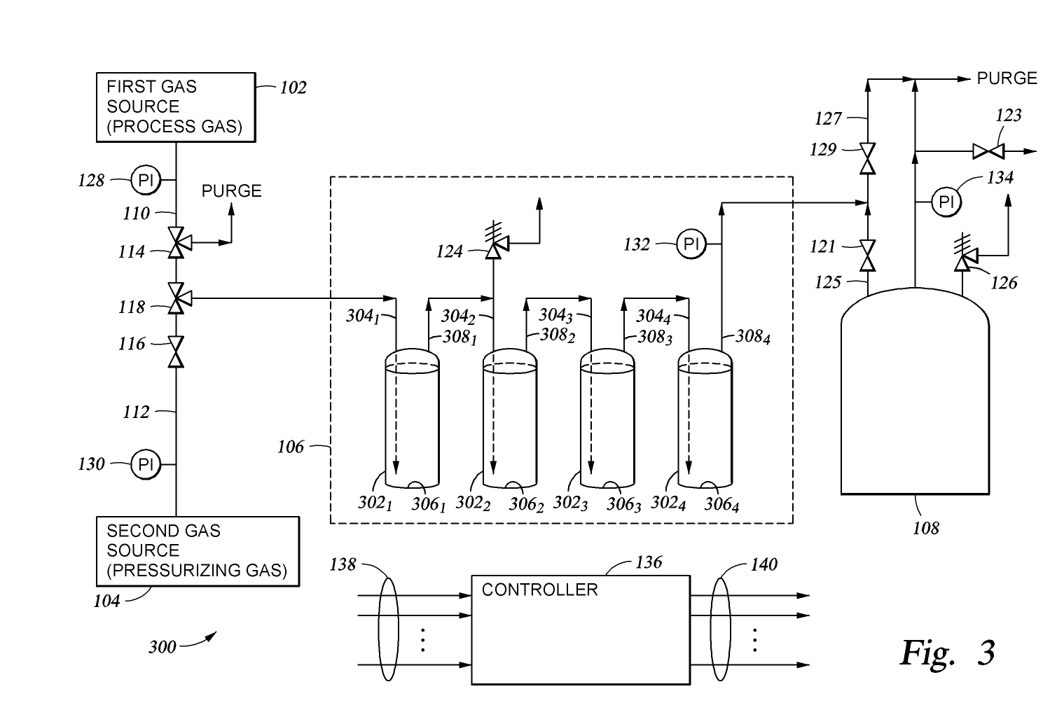

Referring now to FIG. 3, a pressurizing system 300 is shown with a particular embodiment of the gas piston unit 106. Components already described with reference to FIG. 1 are identified by the same reference numerals and will not be described again.

The gas piston unit 106 of the system 300 includes several pressurizing vessels 302₁₋₄ (four shown by way of illustration, but more or fewer may be used in different embodiments). The pressurizing vessels 302 are arranged in series. The process tank 108 is coupled to the last pressurizing vessel 302 in the series. The size of the pressurizing vessels 302 and the process tank 108 may vary depending on the quantities of process gas to be compressed. In a particular embodiment, the four pressurizing vessels 302 are 5 gallons each, and the process tank 108 is 10 gallons. More generally, however, the system may be configured according to a size of the process tank 108 selected to meet the pressurized process gas needs in the subsequent process to which the process gas is fed. The total volume of the vessel series (pressurizing vessels 302₁₋₄ and process tank 108) should be a minimum size to prevent unwanted dilution of the process gas during pressurization. According to one embodiment, the minimum size of the tank series is approximately determined by the following equation:
Vt_{MIN}=Vf×(Pf/Pi)
where Vt_{MIN}=minimum total vessel series volume (liters); Vf=volume of final vessel in the series (liters), i.e., the process tank 108; Pi=initial absolute pressure if the vessel series (atma, before pressurization); and Pf=final absolute pressure of the vessel series (atma, after pressurization).

In one embodiment, each pressurizing vessel 302 includes a gas inlet tube 304₁₋₄ in the form of a dip tube extending from a top of the respective pressurizing vessel 302 to a bottom of the respective pressurizing vessel 302. Thus, the gas inlet tubes 304₁₋₄ terminate near a lower surface 306₁₋₄ of the respective pressurizing vessels 302. In this way, the lower surfaces 306 form baffles for the incoming gases. Each pressurizing vessel 302 also includes a respective gas outlet tube 308₁₋₄. The gas outlet tube in each vessel comes from the top of the respective vessel 302 and feeds the dip tube of the next vessel in the series. The final vessel (the process tank 108) is used to feed the process with the pressurized process gas.

The operation of the system 300 will now be described assuming the process gas is ozone and that the first gas source 102 is an ozone generator. The pressurization process begins by controlling the valves 114 and 118 to fluidly communicate the first gas source 102 with the first pressurization vessel 302₁. Thus, ozone flows from the first gas source 102 through the first supply line 110, into the gas inlet tube 304₁ and is ultimately released into the first pressurization vessel 302₁ at the outlet of the inlet tube 304₁. A sufficient pressure is maintained in the first supply line 110 (as may be determined from the first pressure gauge 128) to purge the volume of the first pressurization vessel 302₁ and fill the first pressurization vessel 302₁ with a relatively uniform volume of ozone. The ozone is then forced through the outlet tube 308₁ of the first pressurization vessel and into the inlet tube 304₂ of the second pressurization vessel 302₂. The flow of ozone from the ozone generator 102 continues in this manner so that each pressurization vessel in the vessel series of the gas piston unit 106 and, ultimately, the process tank 108, is successively filled with ozone. The pressurization of the gas piston unit 106 and the process tank 108 is terminated upon reaching a first predetermined pressure. The first predetermined pressure may be determined, for example, from the fourth pressure gauge 134. In one embodiment, where the pressurization vessels are each 5 gallon tanks and the process tank 108 is a 10 gallon tank, the first pressure is between about 5 psig and about 25 psig.

The pressurization vessels are then isolated from the ozone generator 102 to prevent loss of ozone from the pressurization vessels and process tank and to facilitate the addition of another dry gas from the second gas source. Accordingly, the first valve 114 is closed, the second about 116 is opened and the third valve 118 is set to a position allowing fluid flow from the second gas source 104 to the first pressurization vessel 302₁ via the second supply line 112. In a particular embodiment, the second gas source 104 provides carbon dioxide as the pressurizing gas. As with the process gas, the pressurizing gas is flowed into the inlet tube 304₁ and then released into the first pressurization vessel 302₁ at the terminal and of the inlet tube 304₁. In one embodiment, the provision of the pressurizing gas to the first pressurizing vessel (and consequently to each of the subsequent pressurizing vessels) is controlled to minimize mixing of the pressurizing gas with the ozone contained in the pressurizing vessel. For example, a relatively low flow rate of the pressurizing gas may be maintained. Persons skilled in the art will appreciate that the particular flow rate may depend on the various design considerations for a given implementation of the system 300. Further, embodiments may leverage hardware design considerations of the system 300. For example, by positioning the terminal end of the inlet tubes proximate the respective lower surfaces 302 of the vessels, the energy of the incoming pressurizing gas may be dissipated. Further, the configuration of the system 300 shown in FIG. 3 is particularly well-suited to the use of a denser pressurizing gas (relative to the process gas), such as carbon dioxide (in the case of ozone being the process gas), in that delivery of the carbon dioxide to the lower portion of the respective pressurizing vessels will form a gas piston that stays located in the lower portion of the respective pressurizing vessels but increases volumetrically with the continued supply of carbon dioxide. In this way, the gas piston drives the process gas out of each vessel successively and ultimately into process tank 108.

The process tank 108 will, thus, contain primarily gaseous ozone compressed to a desired pressure (the second predetermined pressure) at which the pressurization process is terminated. In one embodiment, the second predetermined pressure may be between about 30 psig and about 150 psig where the pressurization vessels are each 5 gallon tanks and the process tank 108 is a 10 gallon tank. Upon reaching the second predetermined pressure, the gas piston unit 106 is fluidly decoupled from the second gas source 104 and the process tank may be decoupled from the gas piston unit 106 to prevent unwanted dilution of the pressurized ozone—within limits of the system volume/pressure gain ratio parameters. The process tank 108 is then available as a source of ozone for a given application.

It should be noted that both batch and continuous modes of operation of the system 300 are contemplated. If a continuous operation of pressurized process gas feed is desired, then the pressurization vessels 302₁₋₄ must be replenished with pressurized process gas while the process tank continues to be available as a source of pressurized process gas for a given application. To accomplish this, the pressurization vessels 302₁₋₄ may be vented of their pressure, re-filled with process gas (e.g., the generated ozone mixture), again at the first predetermined pressure, and then brought again to a second pressure with the pressurizing gas in the same manner. This new batch of pressurized gas may then be released into the process tank 108 to reach a third pressure (somewhat less than the second pressure). In one embodiment, the first pressure is 5-25 psig, the second pressure is 30-150 psig, and the third pressure is 27-110 psig. This process replenishes the process tank 108 after its pressure has been diminished by feed to the process. In one embodiment, this re-filling may yield a slightly more dilute process gas mixture because a lesser volume is filled with process gas the second time around. Pressurization vessels 302₁₋₄ may be again used to replenish the process tank 108 as many times as needed.

In another embodiment, several sets (e.g., 3 sets) of pressurization vessels are operated in a “round robin” to maximize the use of the ozone generator, capture all pressurized gas (pressuring gas and process gas) that does not reach the process tank; and minimize the waste of dry pressurizing gas. In this embodiment, a first set of pressurization vessels containing process gas is coupled to the process tank and pressurized by the pressuring gas source until being depleted (or nearly depleted of process gas), at which point the first set is decoupled and a second set is coupled to the process tank. This process is likewise preformed for the switchover from the second to the third set. Once a depleted set is decoupled it can be refilled with process gas as described above. For each switchover, the residual pressurized gas left in a given set following its decoupling from the process tank can be used by applying the residual gas to the next set. In this way the residual gas is used to pressurize the next set and, because the residual gas also includes some amount of process gas, minimizes dilution of process gas in the system.

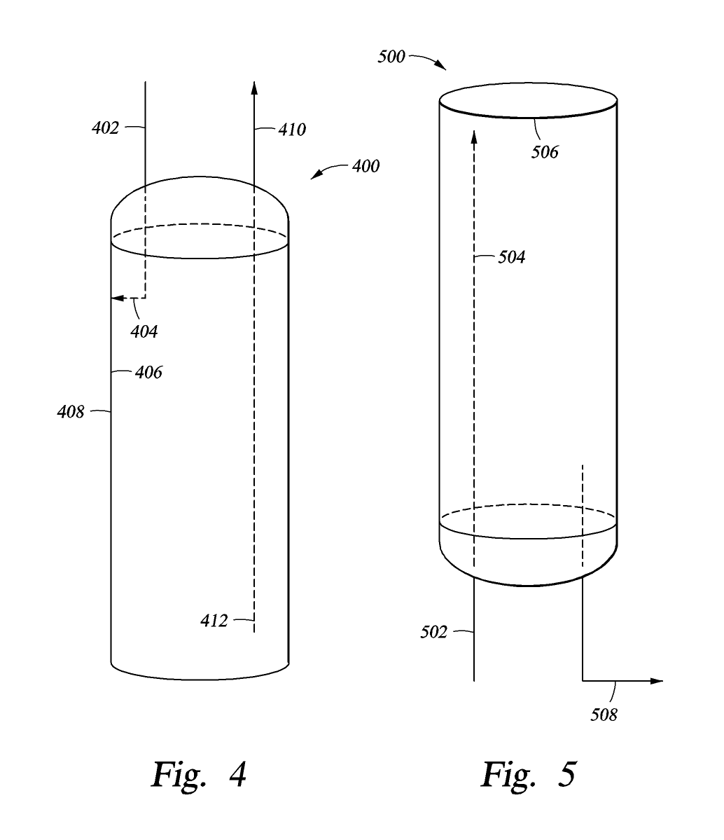

As noted above, it may be desirable to configure the inlet tubes in a manner that minimizes mixing of process gas with pressurizing gas. The provision of the outlet end of the dip tube proximate the respective floors of the pressurizing vessels and process tank is merely one embodiment for accomplishing this objective. Referring to FIG. 4 a side view of a vessel 400 (e.g., a pressurizing vessel or a process tank) is shown in which mitigation of mixing is achieved according to another embodiment. Specifically, the inlet tube 402 (via which the process gas and pressurizing gas are introduced) includes a terminal portion 404 that is bent outwardly toward the inner surface 406 of the tank wall 408. In this configuration, the inner surface functions as a baffle for the impinging gas. As shown, the terminal portion 404 of the inlet tube 402 is located at an upper end of the vessel 400. The vessel 400 further includes an outlet tube 410 with an inlet portion 412 located at a lower end of the vessel 400. Accordingly, for the vessel 400 of FIG. 4 it is contemplated that the process gas is denser than the pressurizing gas so that after vessel 400 is filled with a relatively uniform volume of process gas, the introduction of the pressurizing gas at the upper end of the vessel 400 forms a gas piston which, due to its lesser density, tends to stay above the process gas while volumetrically expanding downwardly, thereby forcing the process gas out of the vessel 400 via the inlet portion 412 of the outlet tube 410.

FIG. 5 shows another embodiment of a vessel 500 substantially corresponding to one of the pressurizing vessels 302 shown in FIG. 3 except that the vessel 500 has been inverted. Thus, an inlet to 502 enters the vessel 500 at a lower end and extends axially to an upper end of the vessel 500. A terminal portion 504 of the inlet to 502 terminates proximate the upper inner surface 506 of the vessel 500. In this configuration, the upper inner surface 506 functions as a baffle for the impinging gas. Like the vessel 400 described above, the vessel 500 is particularly adapted for processes in which the process gas is denser than the pressurizing gas. In operation, the vessel 500 is first filled with a substantially uniform volume of process gas via the inlet tube 502. A relatively less dense pressurizing gas is then fed into the vessel 500 via the inlet tube 502 and forms a volumetrically expanding gas piston at the upper end of the vessel 500, thereby forcing the process gas downward and out of the vessel 500 via an outlet tube 508 located at the lower end of the vessel.

In still other embodiments, the vessels are configured with separate inlet tubes for the process gas and the pressurizing gas. Persons skilled in the art will recognize still other embodiments, all within the scope of the present invention.

In the foregoing, reference has been made to particular features such as particular gases, volumes, hardware design configurations. Persons skilled in the art will recognize that other features may be selected for given embodiments and such selections will be within the scope of the invention. For example, in the foregoing embodiments carbon dioxide was selected as the pressuring gas. However, in other embodiments, other gases such as argon, helium or xenon may be used. The relative densities of the pressurizing gas and the process gas will accounted for to determine an appropriate vessel configuration (e.g., such as the vessels shown in FIGS. 3-5, each being adapted for gases of different relative densities). Further, although embodiments have been described with respect to filling a process vessel with compressed ozone, other process gases may be compressed according the embodiments of the present invention.

Particular processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for pressurizing a process vessel with a gas, the method comprising:
providing a first gas source containing a process gas having a first density;
providing a second gas source containing a pressurizing gas having a second density, wherein the pressurizing gas is selected to be nonreactive with the process gas;
providing a gas piston unit comprising a plurality of pressurizing vessels connected in a series so that an outlet of each pressurizing vessel is connected to an inlet of a next pressurizing vessel in the series, except that an outlet of a last pressurizing vessel in the series is connected to an inlet of the process vessel; wherein an inlet of the first pressurizing vessel is selectively fluidly coupled to the first and second gas sources;
flowing the process gas from the first gas source to the gas piston unit, whereby the process gas enters the inlet of the first pressurizing vessel to fill the first pressurizing vessel and then flows successively to each of the other pressurizing vessel in the series and flows into the process vessel from the last pressurizing vessel;
terminating the flow of process gas upon reaching a first desired pressure in the process vessel; and
flowing the pressurizing gas from the second gas source to the gas piston unit, whereby the pressurizing gas enters the inlet of the first pressurizing vessel and forms a gas piston; wherein the gas piston, with continued flow of the pressurizing gas, volumetrically expands from the first pressurizing vessel and successively into each of the other pressurizing vessels and then into the process vessel, thereby driving the process gas successively through the series of pressurizing vessels and into the process vessel.

2. The method of claim 1, wherein the process gas is ozone and the pressurizing gas is carbon dioxide.

3. The method of claim 1, wherein the pressurizing vessels each have a first volume and the process vessel has a second volume, greater than the first volume.

4. The method of claim 1, wherein the pressurizing vessels each have a first volume and the process vessel has a second volume, greater than the first volume; and wherein the first volume and the number of pressurizing vessels are selected on the basis of the second volume to be filled with the process gas.

5. The method of claim 1, further comprising:
terminating the flow of the pressurizing gas upon reaching a second predetermined pressure; and
isolating the process vessel from the pressurizing vessels.

6. The method of claim 1, further comprising:
flowing the process gas from the process vessel; and
continuously replenishing the process gas in the process vessel by operating the gas piston unit.

7. The method of claim 1, wherein the respective inlets of the pressurizing vessels enter the respective pressurizing vessels at a first end of the pressurizing vessel and each include dip tubes extending axially to an opposite end of the pressurizing vessel; wherein the respective outlets of the pressurizing vessels are located at the first ends of the respective pressurizing vessels; and wherein the first density is less than the second density.

8. The method of claim 1, wherein the respective inlets of the pressurizing vessels enter the respective pressurizing vessels at a first end of the pressurizing vessel and each include dip tubes extending axially to an opposite end of the pressurizing vessel.

9. The method of claim 8, wherein the respective outlets of the pressurizing vessels are located at the first ends of the respective pressurizing vessels.

10. A method for filling a vessel with a fluid, comprising:
fluidly coupling a pressurizing vessel to a first fluid source, containing a first fluid having a first density, in order to at least partially fill the pressurizing vessel with the first fluid; wherein the pressurizing vessel is fluidly coupled to a first vessel of a plurality of vessels, N, connected to each other in series with fluid connections, and wherein a filling vessel is fluidly coupled to a last vessel of the plurality of vessels and is to be filled with the first fluid;
isolating the pressurizing vessel from the first fluid source after at least partially filling the pressurizing vessel to a desired point; and
fluidly coupling the at least partially filled pressurizing vessel to a second fluid source containing a second fluid having a second density and selected to be non-reactive with respect to the first fluid, whereby the first and second fluids remain substantially separate from each other in the pressurizing vessel and the second fluid forms a fluid piston in the pressurizing vessel driving the first fluid from the pressurizing vessel into the first vessel of the plurality of vessels, the first fluid then being caused to flow successively through the plurality of vessels and then from the last vessel into the filling vessel during continued input of the second fluid to the pressurizing vessel.

11. The method of claim 10, wherein the first fluid is ozone and the second fluid is carbon dioxide.

12. The method of claim 10, wherein the pressurizing vessel and each of the plurality of vessels comprises a respective fluid conduit connected to a respective inlet of the respective vessel and terminating at a first end of the respective vessel, and wherein a respective outlet of each respective vessel is located at a second end of the respective vessel, the first and second ends being opposite from each other, and wherein at least the second fluid source is connected to the inlet of the pressurizing vessel.

13. The method of claim 10, wherein the pressurizing vessel and each of the plurality of vessels each have a first volume and the filling vessel has a second volume, greater than the first volume; and wherein the first volume and the number of the pressurizing vessel and each of the plurality of vessels are selected on the basis of the second volume to be filled with the first fluid.

14. The method of claim 10, wherein the pressurizing vessel and each of the plurality of vessels comprises a respective fluid inlet a having terminal opening oriented toward a baffle.

15. The method of claim 14, wherein the baffle is an inner surface of the respective vessels.

16. An apparatus, comprising:
a) a first gas source for providing a process gas having a first density;
b) a second gas source for providing a pressurizing gas having a second density, wherein the pressurizing gas is selected to be nonreactive with the process gas;
c) a gas piston unit comprising a plurality of pressurizing vessels connected in a series so that an outlet of each pressurizing vessel is connected to an inlet of a next pressurizing vessel in the series, except that an outlet of a last pressurizing vessel in the series is connected to the inlet of a process vessel to be pressurized with the process gas; wherein an inlet of the first pressurizing vessel is selectively fluidly coupled to the first and second gas sources; and
d) a controller configured to perform an operation comprising:
i) flowing the process gas from the first gas source to the gas piston unit, whereby the process gas enters the inlet of the first pressurizing vessel to fill the first pressurizing vessel and then flows successively to each of the other pressurizing vessel in the series and flows into the process vessel from the last pressurizing vessel;
ii) terminating the flow of process gas upon reaching a first desired pressure in the process vessel; and
iii) flowing the pressurizing gas from the second gas source to the gas piston unit, whereby the pressurizing gas enters the inlet of the first pressurizing vessel and forms a gas piston;
wherein the gas piston, with continued flow of the pressurizing gas, volumetrically expands from the first pressurizing vessel and successively into each of the other pressurizing vessels and then into the process vessel, thereby driving the process gas successively through the series of pressurizing vessels and into the process vessel.

17. The apparatus of claim 16, wherein the process gas is ozone and the pressurizing gas is carbon dioxide.

18. The apparatus of claim 16, wherein the pressurizing vessels each have a first volume and the process vessel has a second volume, greater than the first volume.

19. The apparatus of claim 16, wherein the pressurizing vessels each have a first volume and the process vessel has a second volume, greater than the first volume; and wherein the first volume and the number of pressurizing vessels are selected on the basis of the second volume to be filled with the process gas.

20. The apparatus of claim 16, wherein the respective inlets of the pressurizing vessels each include terminal portions oriented toward a baffle operative to dissipate energy of the pressurizing gas impinging on the baffle.

21. The apparatus of claim 16, wherein the first gas source is an ozone generator.

22. The apparatus of claim 16, wherein the respective inlets of the pressurizing vessels enter the respective pressurizing vessels at a first end of the pressurizing vessel and each include dip tubes extending axially to an opposite end of the pressurizing vessel.

23. The apparatus of claim 22, wherein the respective outlets of the pressurizing vessels are located at the first ends of the respective pressurizing vessels.

24. An apparatus, comprising:
a first gas source for providing ozone;
a second gas source for providing a pressurizing gas having a second density, wherein the pressurizing gas is selected to be nonreactive with the process gas;
a gas piston unit comprising a plurality of pressurizing vessels connected in a series so that an outlet of each pressurizing vessel is connected to an inlet of a next pressurizing vessel in the series, except that an outlet of a last pressurizing vessel in the series is connected to an inlet of a process vessel to be pressurized with the process gas; wherein the respective terminal ends of the respective inlets of the pressurizing vessels and the process vessel are disposed at a first end of the respective vessel and the respective outlets of the pressurizing vessels are disposed at a second end of the respective pressurizing vessel, the first end being opposite from the second end; wherein the inlet of the first pressurizing vessel is selectively fluidly coupled to the first and second gas sources; wherein the pressurizing vessels each have a first volume and the process vessel has a second volume, greater than the first volume; and wherein the first volume and the number of pressurizing vessels are selected on the basis of the second volume to be filled with the process gas.
